(19) United States
(12) Patent Application Publication
(10) Pub. No.: US 2015/0300864 A1
(43) Pub. Date: Oct. 22, 2015

(54) LIQUID LEVEL SENSOR SYSTEM

(71) Applicant: James P. Wiebe, Wichita, KS (US)

(72) Inventor: James P. Wiebe, Wichita, KS (US)

(21) Appl. No.: 14/689,010

(22) Filed: Apr. 16, 2015

Related U.S. Application Data
(60) Provisional application No. 61/980,356, filed on Apr. 16, 2014.

(51) Int. Cl. G01F 23/00

(52) U.S. Cl. CPC G01F 23/0038

(57) ABSTRACT

A liquid level sensor system for use in a fuel tank, includes an arm that is movable, and constructed to be sufficiently buoyant so that the arm will provide an upward force as the fuel tank is filled with fuel. A sensing subsystem is coupled to the arm and is operable to indicate continuously the amount of fuel in the fuel tank. The sensing subsystem may include a Wheatstone strain gauge, and the system may further include a microprocessor that coupled to the strain gauge to receive electrical signals corresponding to the upward force generated by the arm. A computer program provides instructions to the microprocessor to calibrate the arm according to preselected fuel-level conditions. The sensing subsystem may be located external to the fuel tank to limit the possibility of undesired igniting of the fuel.

### CROSS-REFERENCE TO RELATED APPLICATIONS

The present application claims priority to U.S. Provisional Patent Application Ser. No. 61/980,356, filed on Apr. 16, 2014.

### FIELD OF THE INVENTION

The present invention is a liquid level sensor system that is usable to determine the level of liquids. More particularly, one version of the invention is an electronic fuel level sensor based on a Wheatstone strain gauge.

### BACKGROUND

Current fuel level sensors are based on floats with a variable resistor element, or by determination of fuel level through the utilization of a capacitive probe, which varies in capacitance in proportion to the depth of the fuel enveloping the probe. The float/variable resistor provides is traditional, but prone to breakage or wear of the variable resistor within the mechanism. The capacitive method is more reliable, but will not work in the presence of water, and also requires the presence of an electrical signal directly within the fuel to operate.

### SUMMARY

In one embodiment of the present invention, an arm or mechanical arm is located in a fuel tank, and coupled to a sensing subsystem that includes an electronic Wheatstone strain gauge. The arm is constructed to have sufficient buoyancy so that it will provide an upward force as fuel fills the tank, and the upward force will vary with the amount of fuel in the tank. The strain gauge may be mounted externally to the fuel tank, so that no electrical signals enter the tank. Furthermore, the strain gauge provides an electrical signal to a microprocessor, so that the amount of force provided by the buoyant mechanical arm may be calibrated against various conditions: for instance, a full tank, an empty tank, and various levels in between. The microprocessor, utilizing a software program, provides for the calibration of the strain gauge and further provides an output signal to a fuel gauge. Typically, the output of the microprocessor would have a level of about zero volts equivalent to an empty tank, and an output of five volts equivalent to a full tank, with varying voltages for levels in between.

### BRIEF DESCRIPTION OF THE DRAWINGS

FIG. 1 shows a battery, a strain sensor circuit with microprocessor, and a fuel gauge. The battery provides power both for the strain sensor and associated circuitry, and also for the fuel gauge. The strain sensor arm is shown mounted to the strain sensor electronics, but it need not be.

FIG. 2 shows more clearly the strain sensor arm and strain sensor circuit. Included on the circuit board are a microprocessor and the analog electronics required to read the strain sensor data.

FIG. 3 shows the strain sensor arm mounted to a buoyant mechanical arm, which would descend down into the fuel tank. The angle of the arm may be varied to fit within the mechanical constructs of the various types of fuel tank. The mechanical arm is buoyant, so that as fuel fills the tank, an upward force will be placed on the strain sensor arm. Because the strain gauge is mounted on the bottom of the strain sensor arm, the strain gauge will be experience tension force.

FIG. 4 shows a close-up of the strain sensor arm, also showing clearly the strain sensor. As fuel fills the tank, the upward force from the buoyant mechanical arm will place the strain sensor in tension.

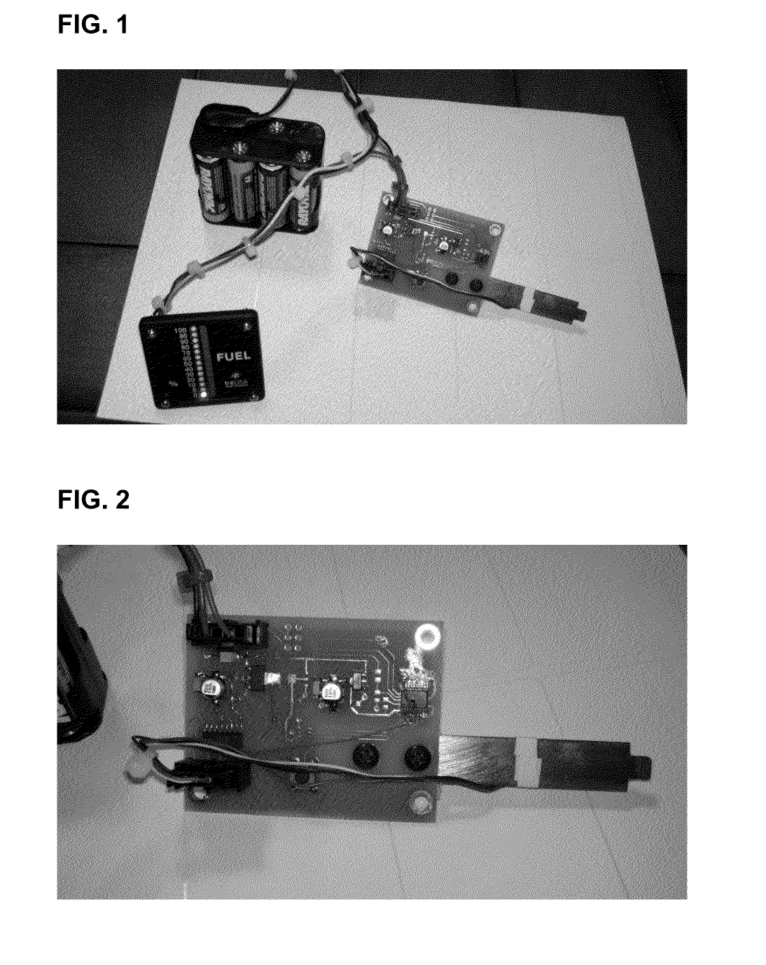

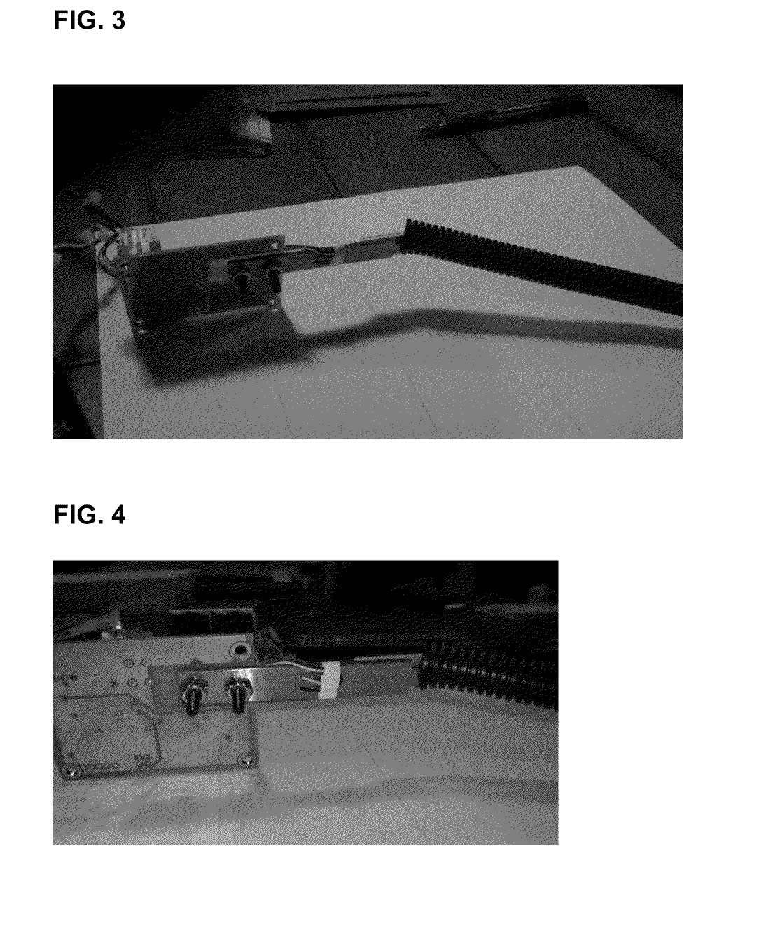

### DETAILED DESCRIPTION

The present invention provides a system and method to measure fuel (or any liquid) remaining in a tank of any kind. The invention may be thought of as a liquid-level sensor system for use in a fuel tank that includes an arm that is movable, and constructed to be sufficiently buoyant so that the arm will provide an upward force as the fuel tank is filled with fuel. A sensing subsystem is coupled to the arm and is operable to indicate continuously the amount of fuel in the fuel tank. As described below, the sensing subsystem may include a Wheatstone strain gauge, and may further include a microprocessor coupled to the strain gauge to receive electrical signals corresponding to the upward force generated by the arm. A computer program is also provide to instruct the microprocessor to calibrate the arm according to preselected fuel-level conditions, such as empty, full, and various intermediate levels such as one quarter full, one half full, etc. The sensing subsystem may also be located external to the fuel tank to limit the possibility of an electrical signal providing a spark that ignited the fuel.

One embodiment utilizes the following elements:
10) a strain gauge mounted on a
12) strain gauge arm
14) with the strain gauge arm mounted to a buoyant mechanical arm
16) with an analog circuit to amplify the strain gauge signal
18) and with the output of the analog circuit connected to a microprocessor so that the microprocessor may correct and calibrate the signal for empty, full and inbetween conditions
20) providing the output to an electrical connector, so that it may be attached to any fuel gauge
22) and a power source to supply power to the circuitry.

10) The strain gauge is a classic Wheatstone resistive bridge, which detects minute changes in tension (or compression, although tension would be the preferred embodiment).

12) The strain gauge is mounted on a short arm, usually built out of metal. The strain gauge is glued or bonded to the metal arm.

14) The buoyant mechanical arm is merely an extension of the metal arm, placed at a descending angle greater than 1 degree, so that it is eventually submersed in a tank to the near bottom of that tank. The preferred embodiment would include sufficient buoyancy so that the strain gauge would register an increasing strain as the tank fills with fuel (or fluid of any type). Even metal (without any sort of attached buoyancy device, such as a float) will register a variance in strain as it displaces a fluid, although a material with higher buoyancy (such as a sealed hollow tube) would be preferred.

16) The analog circuit is responsible for amplifying the output of the Wheatstone bridge from a low level (such as a few millivolts) so that it may be read by a microprocessor. The analog circuit may also provide some filtering to reduce the effect of sloshing.

18) The microprocessor is responsible for analyzing and filtering the incoming signal so that short term variations (such as sloshing) are integrated out, and also so that a calibration methodology (empty tank, full tank and inbetween levels) are accommodated. The microprocessor may have a momentary switch attached to it so that the user can signal calibration levels.

20) The microprocessor provides the fuel level output to a connector, either through a built in Digital to Analog Converter, or through an external ADC.

22) A power supply is required to power this circuitry, and also the fuel gauge.

Other embodiments could include mounting on the bottom or on the side of the tank. This would change the angle of the buoyant mechanical arm.

The present invention provides a way to measure the level of liquid such as fuel in any container, such as a tank, by analyzing the strain on a Wheatstone resistive bridge, thus allowing the fuel tank level to be determined accurately without immersing any electrical circuit into the tank.

What is claimed:

1. A liquid level sensor system for use in a fuel tank, comprising:
an arm that is movable, and constructed to be sufficiently buoyant so that the arm will provide an upward force as the fuel tank is filled with fuel;
a sensing subsystem coupled to the arm that is operable to indicate continuously the amount of fuel in the fuel tank.

2. The system of claim 1, wherein the sensing subsystem includes a Wheatstone strain gauge.

3. The system of claim 2, further including a microprocessor coupled to the strain gauge to receive electrical signals corresponding to the upward force generated by the arm, and a computer program that allows the microprocessor to calibrate the arm according to preselected fuel-level conditions.

4. The system of claim 1, wherein the sensing subsystem is located external to the fuel tank.

5. The system of claim 3, wherein the sensing subsystem is located external to the fuel tank.
